(19) United States
(12) Patent Application Publication
(10) Pub. No.: US 2015/0242861 A9
(43) Pub. Date: Aug. 27, 2015

(54) METHOD AND SYSTEM FOR ASSISTING USER AND ENTITY COMPLIANCE USING A COMMUNICATION DEVICE

(71) Applicant: Valli BALDASSANO, Ottsville, PA (US)

(72) Inventor: Valli BALDASSANO, Ottsville, PA (US)

(21) Appl. No.: 14/082,907

(22) Filed: Nov. 18, 2013

Related U.S. Application Data
(60) Provisional application No. 61/730,258, filed on Nov. 27, 2012.

(51) Int. Cl. G06Q 30/00

(52) U.S. Cl. CPC G06Q 30/018

(57) ABSTRACT

A communication device for assisting a user with compliance with a set of regulations includes: a display device, an input device, a transmitting device, a receiving device, a non-transitory computer-readable storage medium, and a processing device. The transmitting device is configured to transmit at least a user identifier associated with the communication device. The receiving device is configured to receive customized content based on the user identifier associated with the communication device. The non-transitory computer-readable storage medium is configured to store a program. The processing device is configured to execute the program. The program comprises a plurality of connected modules to assist a user with compliance with a set of regulations, the plurality of modules including at least a reporting module, a training module, a spending module, and an information module.

### FIELD

The present disclosure relates to the assisting of user and entity with compliance using a communication device, specifically the use of interconnected modules executed by a processor of a communication device that utilize hardware of the communication device to assist the use with compliance with a set of rules or regulations.

### BACKGROUND

Many industries operate under various regulations, rules, requirements, and codes of conduct set forth by regulatory agencies, governments, and sometimes the organization itself. As technology has advanced and more and more of industry operations have entered the public eye, there has been an increase in the amount of regulatory control taken on these industries and scrutiny when reviewing regulated actions. As a result, many companies and institutions have had to increase the amount of resources devoted to maintaining compliance with these regulations.

Companies often times may employ compliance personnel, such as a compliance officer, to manage the maintaining of compliance for the company and its employees. Compliance personnel often use various software programs to manage data related to compliance and to communicate with employees and relevant parties. With the advancement of technology in the mobile space, employees may often time carry mobile communication devices that enable them to communicate back with compliance personnel. However, there is a lack of devices available to adequately manage compliance for users and system operators to make the process easier, and more efficient than using traditional methods.

Thus, there is a need for a technical solution to assist employees with complying with a set of regulations using a communication device specially configured for providing both the user and system operator with sufficient information for complying with the set of regulations.

### SUMMARY

The present disclosure provides a description of a system and method for assisting a user with compliance with a set of regulations.

A communication device includes: a display device, an input device, a transmitting device, a receiving device, a non-transitory computer-readable storage medium, and a processing device. The transmitting device is configured to transmit at least a user identifier associated with the communication device. The receiving device is configured to receive customized content based on the user identifier associated with the communication device. The non-transitory computer-readable storage medium is configured to store a program. The processing device is configured to execute the program. The program comprises a plurality of connected modules to assist a user with compliance with a set of regulations. The plurality of modules includes a reporting module, a training module, a spending module, and an information module. The training module is configured to: display, on the display device, a compliance scenario; receive, via the input device, a user response to the display compliance scenario; identify a scenario explanation based on the received user response; display, on the display device, the identified scenario explanation; and cause the reporting module to report, via the transmitting device, the received user response. The spending module is configured to: receive, via the input device, an indication of a spending category; cause the reporting module to report, via the transmitting device, the received indication of a spending category; receive, via the receiving device, aggregate spending data corresponding to the indicated spending category; display, on the display device, the received aggregate spending data; and identify, in the received aggregate spending data, an indication of noncompliance with at least one regulation in the set of regulations. The information module is configured to: display, on the display device, a plurality of content items based on at least the received customized content; receive, via the input device, an indication of a selected content item of the plurality of content items; display, on the display device, content associated with the selected content item; receive, from another module, an indication of compliance or noncompliance with at least one regulation in the set of regulations; and display, on the display device, content associated with the at least one regulation.

A method for assisting a user with compliance with a set of regulations includes: transmitting, by a transmitting device, a user identifier associated with a communication device; receiving, by a receiving device, customized content based on the user identifier; storing, in a non-transitory computer-readable storage medium, a program; and executing, by a processing device, the stored program, wherein the program comprises a plurality of connected modules. The plurality of modules includes a reporting module, a training module, a spending module, and an information module. The training module is configured to: display, on the display device, a compliance scenario; receive, via the input device, a user response to the display compliance scenario; identify a scenario explanation based on the received user response; display, on the display device, the identified scenario explanation; and cause the reporting module to report, via the transmitting device, the received user response. The spending module is configured to: receive, via the input device, an indication of a spending category; cause the reporting module to report, via the transmitting device, the received indication of a spending category; receive, via the receiving device, aggregate spending data corresponding to the indicated spending category; display, on the display device, the received aggregate spending data; and identify, in the received aggregate spending data, an indication of noncompliance with at least one regulation in the set of regulations. The information module is configured to: display, on the display device, a plurality of content items based on at least the received customized content; receive, via the input device, an indication of a selected content item of the plurality of content items; display, on the display device, content associated with the selected content item; receive, from another module, an indication of compliance or noncompliance with at least one regulation in the set of regulations; and display, on the display device, content associated with the at least one regulation.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for assisting a user with compliance with a set of regulations in accordance with exemplary embodiments.

FIG. 2 is a block diagram illustrating a communication device for use in the system of FIG. 1 in accordance with exemplary embodiments.

FIG. 3 is a block diagram illustrating the interconnection of modules stored in the communication device of FIG. 2 accordance with exemplary embodiments.

FIG. 4 is a flow diagram of a training module used to assist a user with compliance in accordance with exemplary embodiments.

FIG. 5 is a flow diagram of a spending module used to assist a user with compliance in accordance with exemplary embodiments.

FIGS. 6A-6L are illustrations of a graphical user interface of the communication device of FIG. 2 in accordance with exemplary embodiments.

FIG. 7 is a flow chart illustrating an exemplary method for assisting a user with compliance with a set of regulations in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

System for Assisting a User with Compliance

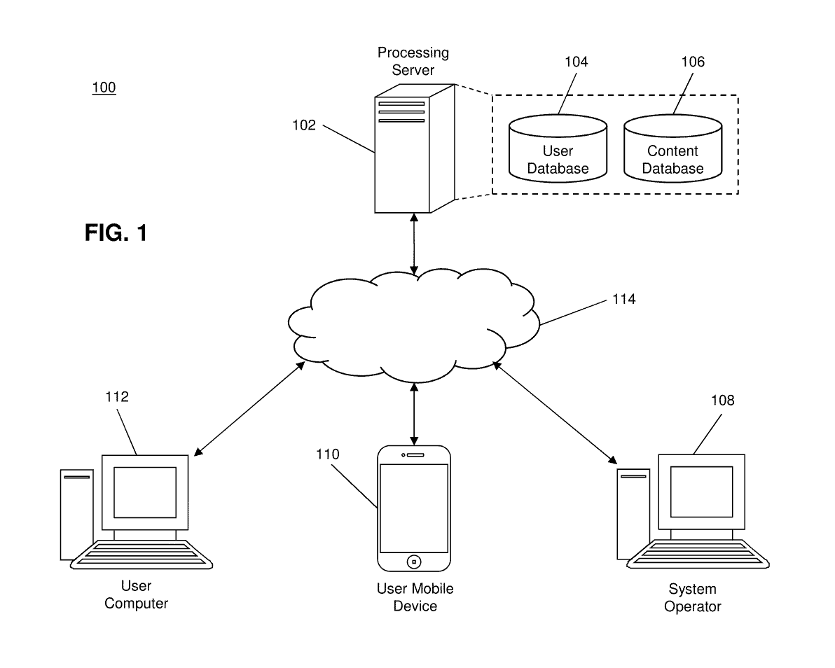

FIG. 1 illustrates a system 100 for assisting a user with compliance with a set of regulations. As discussed herein, the term “set of regulations” may include any rules, regulations, codes of conduct, guidelines, policies, procedures, principles, plans, etc. that a user must comply with (e.g., follow, conform to, etc.). Regulations may be set forth by a regulatory agency, government, an organization, a company, etc. For example, an employee of a pharmaceutical company may be required to follow regulations set forth by a governmental agency, a private organization, and the pharmaceutical company itself.

The system 100 may include a plurality of users who must maintain compliance with the set of regulations. Each user may use a communication device to communicate with the system 100 via a network 114. The network 114 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

The communication devices used to communicate with the system 100 may be any communication device suitable for performing the functions as disclosed herein and may vary from application to application. For example, an employee who travels often, such as a pharmaceutical representative, may use a user mobile device 110 for assistance with compliance, whereas an administrative employee who works in an office may use a user computer 112. Devices suitable for the user mobile device 110 and the user computer 112 will be apparent to persons having skill in the relevant art and may include desktop computers, laptop computers, notebook computers, tablet computers, smart phones, cellular phones, etc. The user mobile device 110 and the user computer 112 may include a combination of hardware and software configured to perform the functions as disclosed herein, as discussed in more detail below.

The system 100 may also include a system operator 108. The system operator 108 may be operated by an additional user (e.g., a compliance officer, management employee, etc.) that may monitor compliance of and control content distributed to other users as discussed in more detail below. The system operator 108 may be any type of system suitable for performing the functions as disclosed herein, such as that of the user mobile device 110 or the user computer 112. In some embodiments, the system operator 108 may use additional modules or modified version of modules to perform additional functions that may be unavailable to general users. The system operator may provide content to a processing server 102. Content provided to the processing server 102 may include any type of content suitable for assisting a user with compliance with the set of regulations as will be apparent to persons having skill in the relevant art, such as scenarios, questions, spending data, misconduct reports, regulations, rules, policies, etc.

The processing server 102 may be a single computer system or a combination of computer systems configured to perform the functions as disclosed herein. Types of systems suitable for use as the processing server 102 will be apparent to persons having skill in the relevant art. The processing server 102 may store the received content in a content database 106. The processing server 102 may also include a user database 104. The user database 104 may be configured to store user profiles that associate users (e.g., employees) with corresponding devices, such as a user with the user computer 112, a different user with the user mobile device 110, and an operator (e.g., a compliance officer) with the system operator 108.

The processing server 102 may include a user database 104 and a content database 106. Data stored in the user database 104 and the content database 106 (“the databases”) may be stored on any type of suitable computer readable media, such as optical storage (e.g., a compact disc, digital versatile disc, Blu-ray disc, etc.) or magnetic tape storage (e.g., a hard disk drive, flash drive, etc.). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as a network 114).

In some embodiments, the user database 104 may be configured to associate users with content included in the content database 106. For example, a user of the user mobile device 110 may be associated with a first set of content in the content database 106, whereas a user of the user computer 112 may be associated with a second set of content in the content database 106. In some instances, the associations may be set by the system operator 108 or by guidelines, rules, etc. provided by the system operator 108.

Associating content with a user may be beneficial as not all users may need to receive the same content to assist with compliance. For example, a pharmaceutical representative may benefit from training scenarios and regulations regarding spending money on a potential client physician, but an administrative employee may not. The pharmaceutical representative may be associated in the user database 104 with client spending scenarios and regulations, which may allow the corresponding content in the content database 106 to be distributed to that user and not the administrative employee.

The processing server 102 may be further configured to transmit the corresponding content for each user to the corresponding device. In an exemplary embodiment, the content may be received by the user device, stored in memory, and used by a program also stored in memory and executed by the device. The program may include a plurality of modules, as discussed in more detail below, configured to assist the user with compliance with the set of regulations.

In one embodiment, the program and included modules may be different for each user, such as based on user permissions and content. For example, the user computer 112 may include a question module to allow the user to ask compliance-related questions, whereas the user mobile device 110 may not include the module. In some embodiments, the system operator 108 may include additional features, such as for adding content, for setting user permissions, and for associating users or user groups with specific content.

The processing server 102 may be further configured to store data related to compliance for each user in the user database 104, such as for the purposes of maintaining information for auditing. For example, the processing server 102 may store times, dates, and results for all compliance scenarios, may store times and dates when spending data is access, may store all form input data and generated forms, etc. Data that may be necessary to be kept by the processing server 102 for auditing purposes will be apparent to persons having skill in the relevant art.

### User Communication Devices

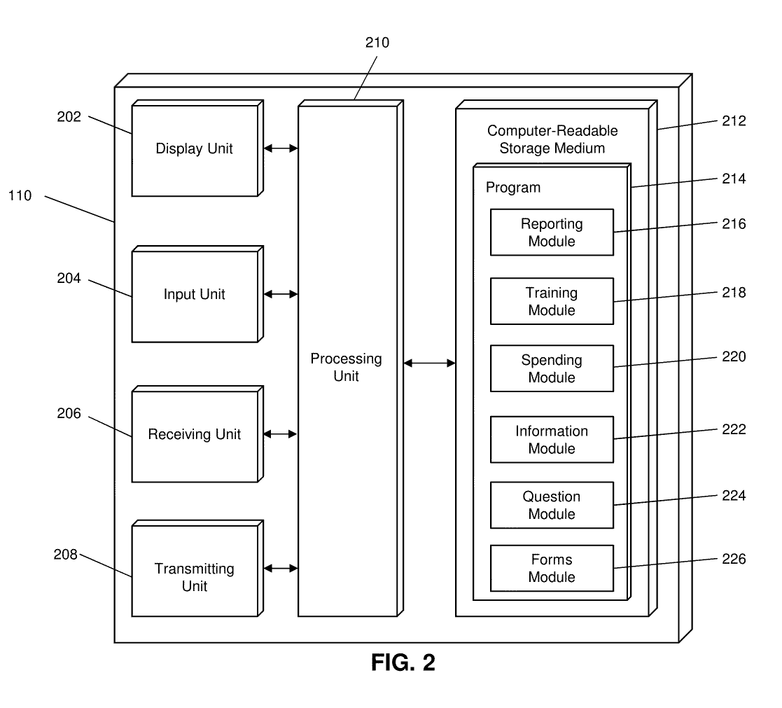

FIG. 2 illustrates an exemplary user communication device for use in the system 100 for assisting a user with compliance with a set of regulations. It will be apparent to persons having skill in the relevant art that although the communication device illustrated in FIG. 2 is the user mobile device 110, this is for illustration purposes only as any type of communication device as discussed herein may be used to assist a user with compliance with a set of regulations.

The user mobile device 110 may include a display unit 202. The display unit 202 may be configured to display content (e.g., text, images, video, etc.) to a user. The display unit 202 may be any type of display suitable for displaying content to a user as will be apparent to persons having skill in the relevant art, such as a liquid crystal display (LCD), a light emitting diode (LED) display, a touch screen display, or a capacitive touch screen display.

The user mobile device 110 may also include an input unit 204. The input unit 204 may be configured to receive input from the user, such as responses to prompts or inquiries, indications, selections, questions, requests, etc. The input unit may be any type of input suitable for performing the functions as discussed herein as will be apparent to persons having skill in the relevant art, such as a keyboard, touch screen, click wheel, microphone, camera, etc. In some instances, the input unit 204 may include multiple input units interfaced together, such as including both a keyboard and a touch screen. In one embodiment, the display unit 202 and the input unit 204 may be a single unit, such as a touch screen display.

The user mobile device 110 my further include a receiving unit 206. The receiving unit 206 may be configured to receive data, such as via the network 114. The data may include content, which may include customizable content included in the content database 106 of the processing server 102, answers to questions, responses to reports of misconduct, training scenarios, regulations for display, etc. In some instances, the received content may include general content available to all users, and/or combined with customized content based on the user and/or the specific user mobile device 110. In some embodiments, the receiving unit 206 may be configured to receive data from multiple networks, such as utilizing both a Wi-Fi network and a mobile communication network. In an exemplary embodiment, the receiving unit 206 may also be configured to regularly monitor for updated content, responses, etc.

In one embodiment, the customized content may be based on a user identifier associated with the user mobile device 110, such as a media access control (MAC) address or authentication information (e.g., a username and password provided by the user to the application program 214). In another embodiment, at least a portion of the customized content may be based on location. For example, the user mobile device 110 may be configured to identify its geographic location, which may then be transmitted to the processing server 102 to receive location-based content or may be used to filter received content based on the location. In such an instance, the information module 222 may include, for example, laws based on the area where the user mobile device 110 is located. Methods for locating a user for the providing of location-based content will be apparent to persons having skill in the relevant art (e.g., GPS, Wi-Fi and mobile telephony geolocation, self-reporting, etc. and combinations thereof).

The user mobile device 110 may also include a transmitting unit 208. The transmitting unit 208 may be configured to transmit data from the user mobile device 110 to an external device, such as the processing server 102. The transmitting unit 208 may be configured to transmit data in any format or method suitable for performing the functions as disclosed herein as will be apparent to persons having skill in the relevant art. In some embodiments, the receiving unit 206 and the transmitting unit 208 may be a single unit configured to both transmit and receive data.

The user mobile device 110 may also include a computer-readable storage medium 212. The computer-readable storage medium 212 may be any type of storage suitable for performing the functions as disclosed herein as will be apparent to persons having skill in the relevant art, such as a hard disk drive, a solid state drive, external removable memory (e.g., flash memory, Secure Digital memory, etc.), etc. The computer-readable storage medium 212 may be configured to store an application program 214. The application program 214 may be a software program (e.g., a “Compliance Center”) that includes a plurality of interconnected modules, discussed in more detail below, configured to assist a user of the user mobile device 110 with compliance with the set of regulations. In one embodiment, the application program 214 may include at least a reporting module 216, a training module 218, a spending module 220, and an information module 222. In a further embodiment, the application program 214 may further include a question module 224 and/or a forms module 226.

The user mobile device 110 may further include a processing unit 210. The processing unit 210 may be configured to execute the application program 214 in order to assist the user with compliance with the set of regulations. The processing unit 210 may manage data included in the computer-readable storage medium 212 and may be configured to facilitate the transfer of data to and from each of the display unit 202, the input unit 204, the receiving unit 206, and the transmitting unit 208, such as based on programming in each of the respective modules of the application program 214, as discussed in more detail below. For example, the processing unit 210 may, when the receiving unit 206 is detected as receiving a content update, store the received updated content in the computer-readable storage medium 212 and cause the display unit 202 to display an indication to the user of the receipt of updated content.

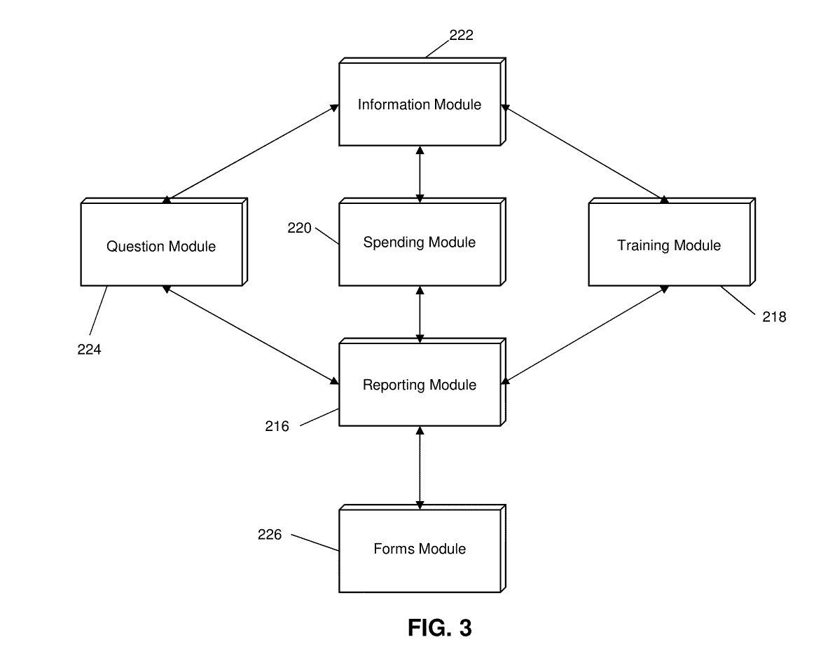

FIG. 3 is an illustration of each of the plurality of modules included in the application program 214 and how each of the modules may be configured to communicate with one another to more efficiently and effectively assist the user with compliance. It will be apparent to persons having skill in the relevant art that the configuration illustrated in FIGS. 2 and 3 is one example for illustration purposes only, and the user mobile device 110 is not limited to this exemplary configuration.

### Reporting Module

The reporting module 216 may be configured to report data regarding user actions and compliance via the transmitting unit 208. In one embodiment, the data may be reported by the reporting module (e.g., using the transmitting unit 208) to the processing server 102, where the data may be viewed (e.g., monitored, analyzed, etc.) by the system operator 108. The data reported by the reporting module 216 may vary based on application and may be received from another module included in the application program 214, as discussed in more detail below. For example, the reporting module 216 may be configured to report questions receiving from the question module 224 to the processing server 102 to be answered for the user.

In some embodiments, the reporting module 216 may be configured to allow a user to report misconduct (e.g., noncompliance). To report misconduct, the input unit 204 may receive input from the user, such as an allegation of misconduct, which may include at least one of text, audio, images, and video regarding an incident of misconduct and/or noncompliance by the user or another. In one embodiment, the processing unit 210 may store the received input in the computer-readable storage medium. The processing unit 210 may cause the transmitting unit 208 may transmit the allegation of misconduct, such as to the processing server 102. In an exemplary embodiment, the allegation of misconduct may be transmitted anonymously such as to protect the identity of the user. The receiving unit 206 may receive a response to the allegation of misconduct (e.g., from the system operator 208), and the processing unit 210 may cause the display unit 202 to display the received response.

In some embodiments, the reporting module 216 may also be configured to report attendance by the user at a training event, such as a live training seminar, a continuing education seminar, a conference, or any other type of event for which a user may be required to or benefited by reporting attendance. The transmitting unit 208 may be configured to report the attendance to the processing server 102, which may then be viewed by the system operator 108 for assisting with the compliance of the user with the set of regulations. Methods for verifying attendance of the user to an event using the user mobile device 110 will be apparent to persons having skill in the relevant art and may include, for example, scanning of a display bar code, scanning of a reading device using near field communication, connecting to a localized network (e.g., a local Wi-Fi network), receiving a physical file at the location, imaging a specific object or image at the location, etc.

### Training Module

The training module 218 may be a module configured to train a user for compliance with the set of regulations. The training module 218 may present the user with a plurality of compliance scenarios. The compliance scenarios may be any type of scenario, question, prompt, etc. designed to assist the user with compliance, assess the user's level of compliance or knowledge of regulations, or otherwise train the user with compliance. The compliance scenario may be a question, prompt, or fact pattern where the user must select from a plurality of responses, such as multiple choice, true or false, fill in the blank, matching, etc. For example, a compliance scenario may present the user with a fact pattern and four responses indicating different reactions the user may take.

The training module 218 may be configured to identify a response indicated by the user and then display an explanation to the user based on their response. For example, if the user selects a correct response, the explanation may indicate that the user was correct, whereas if the user selects an incorrect response, the explanation may indicate that the user was incorrect and further display the correct answer and reasoning behind it. The training module 218 may transmit the user's selected response to the reporting module 216, for reporting to the processing server 102. The system operator 108 may be able to view the user's reported responses, which may be used to assess the user's compliance and may enable the system operator 108 to select further content in the content database 106 to be distributed to the user for additional assistance with compliance.

In some instances, a compliance scenario may not have a clear correct or incorrect response. In such an instance, a user response may be assigned a score based on the level of correctness of a response (e.g., the most correct response may be worth 1,000 points, the next correct response may be worth 750, etc.). The training module 218 may transmit the response included with the point value to the reporting module 216 for reporting. In some embodiments, the user may be able to view the points awarded to the user for each compliance scenario. The user may also be able to view a total number of points, which may also be used to provide the user with an assessment of compliance. In some instances, the training module 218 may be configured to display a leaderboard based on the point scores of each user for each response or a plurality of responses. In a further instance, the leaderboard may only be accessible by the system operator 108.

As discussed in more detail below, users may earn points via questions or compliance scenarios presented while using different modules or features of the program 214. In some embodiments, the leaderboard may be configured to display the total point scores for each user including points earned inside the training module 218 and points earned outside of the training module. In some instances, the leaderboard may also include leaderboards for each separate category (e.g., training module 218 points and non-training module 218 points). The leaderboard may also include categories that may be used for sorting or categorizing. For example, additional leaderboards may be included that show users in a specific region (e.g., state, municipality, country, etc.), department (e.g., research and development, marketing, finance, etc.), or sorted by one or more categories (e.g., by name). Such sorting and display methods may foster competition among users, departments, regions, etc., which may further increase compliance. Names of users may be listed on the leaderboard by first name, full name, first name and last initial, last name, or any other manner that will be apparent to persons having skill in the relevant art. In some instances, an administrator or each individual user themselves may specify display of the users or their own name on the leaderboard.

The training module 218, as illustrated in FIG. 3, may be configured to be interconnected with the information module 222. For example, if the user is presented with a compliance scenario and selects a response that is incorrect, the user may be required to view information using the information module 222 prior to continuing, such as the regulation, rule, policy, etc. at issue in the question. In some instances, the information module 222 may display a specific rule or regulation. In other instances, the information module 222 may display the rules or regulations generally. In one embodiment, the system operator 108 may indicate compliance scenarios where information may be provided to a user following the user response. In a further embodiment, the system operator 108 may indicate criteria for providing the information (e.g., based on the response or point value) and indicate if the user is required to view the information or if viewing the information is optional.

Methods for presenting compliance scenarios using the training module 218 will be apparent to persons having skill in the relevant art. For example, the training module 218 may use a bank of compliance scenarios (e.g., stored in the computer-readable storage medium), or may display specific scenarios based on (e.g., or included in) customized content from the content database 106 selected for the specific user as indicated in the user database 104.

In some instances, the system operator 108 may be able to add content (e.g., additional scenarios) to the training module. For example, as regulations get modified or added, the system operator 108 may devise additional or revised scenarios to compensate for the change in the set of regulations. The new or revised scenarios may then be stored in the content database 106, which may be transmitted to the user mobile device 110 for display on the display unit 202. In one embodiment, the display unit 202 may display an indication to the user indicating that new content has been received.

In some instances, scenarios or questions presented as part of the training module 218 may be presented to the user during user interactions with different modules inside of the program 214. For example, the user may view information that is presented while inside of the information module 222, discussed in more detail below, and may come across a compliance scenario or question. The user may then answer the scenario or question and may be scored based on their answer, such as discussed herein. The scores may then be taken into account similar to scores generated while answering questions or scenarios inside of the training module 218. In some embodiments, users may encounter training scenarios or questions in any of a number of modules, such as while reading compliance blogs, viewing reports, reviewing questions asked by other users, reviewing new content, etc. Such instances may provide users with opportunities to earn additional points outside of the training module 218, which may provide further incentive for users to utilize additional modules and aspects of the program 214.

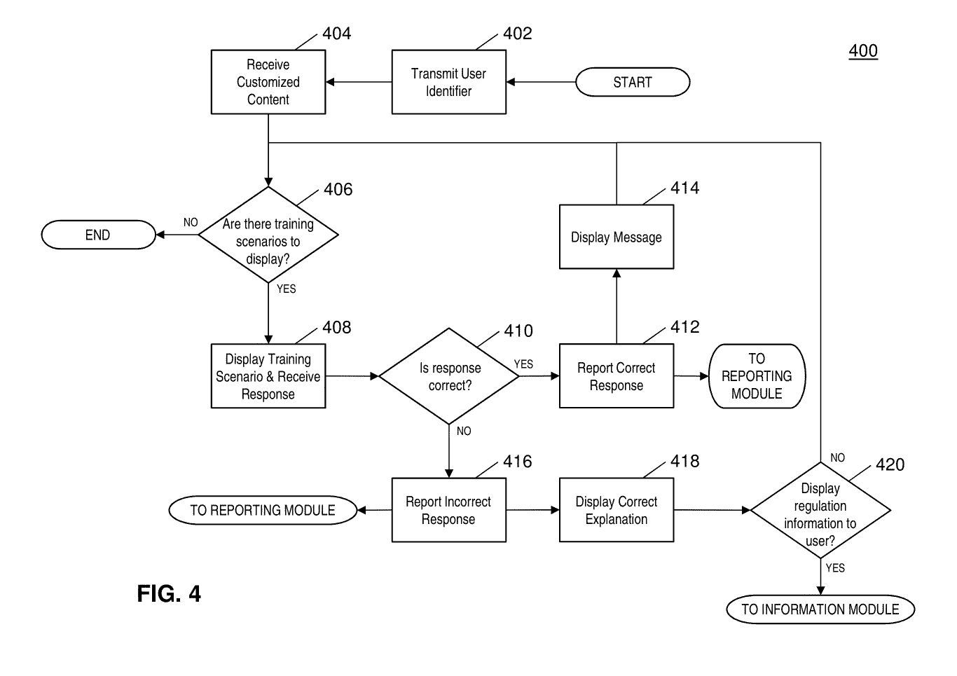

FIG. 4 illustrates a process 400 for assisting a user with compliance with the set of regulations using the training module 218. In step 402, the processing unit 210 may cause the transmitting unit 208 to transmit a user identifier to the processing server 102. The user identifier may be any type of unique value suitable for identifying the user of the computing device (e.g., the user mobile device 110), such as a media access control (MAC) address, an e-mail address, a phone number, etc. In one embodiment, the user identifier may include authentication information, such as a username and/or password, a personal identification number, a fingerprint, vocal recognition, etc.

In step 404, the receiving unit 206 may receive content from the processing server 102 that may include customized content for the specific user identified using the user identifier. In one embodiment, the customized content may include compliance scenarios distributed to the user of the user mobile device 110 but not to all users. In a further embodiment, the customized content may include at least one compliance scenario specific to the user. In step 406, the processing unit 210 may determine if there are compliance scenarios to be displayed. If there are not, such as if the user has already completed all required compliance scenarios, then the process 400 may end. The end of the process may include displaying, via the display unit 202, a message to the user indicating that they have no compliance scenarios to complete at the present time.

If the processing unit 210 determines there is a compliance or training scenario to display, then, in step 408, it may display the scenario via the display unit 202, and the input unit 204 may receive input from the user indicating a response to the scenario. In step 410, the processing unit 210 may determine if the response is correct. If the response is correct, then, in step 412, the training module 218 may notify the reporting module 216 of the correct response, which the reporting module 216 may then report, via the transmitting unit 208, to the processing server 102. In step 414, the display unit 202 may display a message to the user indicating that their response is correct. Then, the process 400 may return to step 406 to determine if there are additional scenarios for the user to complete (not shown).

If, in step 410, the response is determined to be incorrect, then, in step 416, the training module 218 may notify the reporting module 216 of the incorrect response. The reporting module 216 may report the incorrect response to the processing server 102, where the system operator 108 may be notified as part of an assessment of the compliance of the user. In step 418, the display unit 202 may display an explanation to the user as to the correct response to the compliance scenario that had been presented.

In step 420, the processing unit 210 may determine if regulation information (e.g., for a regulation corresponding to the presented scenario) is to be displayed to the user. If so, then the application program 214 may switch to the information module to display the corresponding regulation, as discussed in more detail below. If the information is not to be displayed, then the process 400 may return to step 406 to determine if additional scenarios are to be presented. In one embodiment, the system operator 108 may indicate (e.g., in the user database 104) guidelines for displaying the regulation to the user, such as based on the user, the response to the scenario, user response history to all scenarios, user response history to scenarios involving the same regulation, etc.

### Spending Module

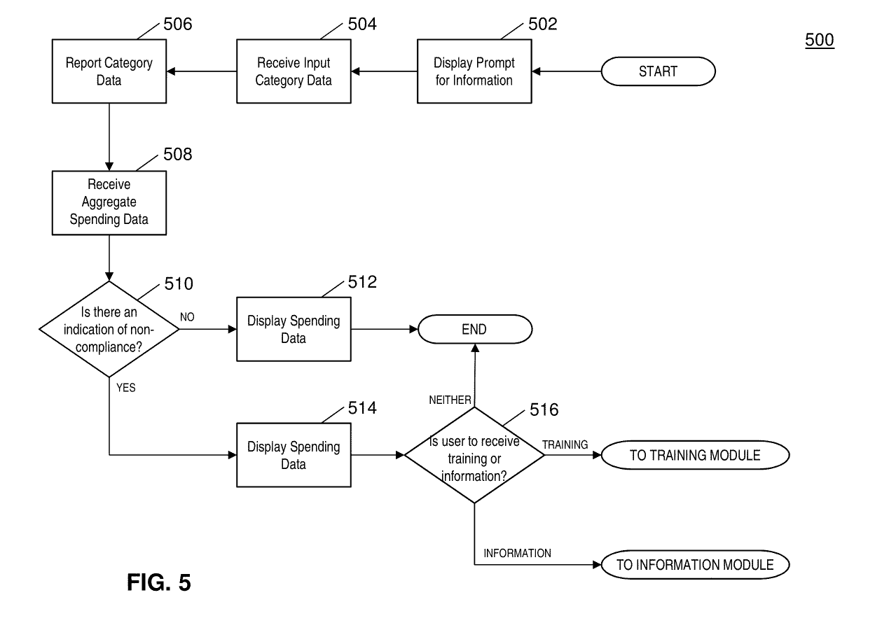

The spending module 220 may be a module configured to assist a user with identifying aggregate spending in order to maintain compliance with the set of regulations. FIG. 5 illustrates a process 500 for displaying spending data to a user to assist with compliance with the set of regulations.

In step 502, the display unit 202 may display a prompt for information to the user. The prompt for information may include a prompt for a selection of a category from a plurality of categories. For example, a pharmaceutical representative may select from a plurality of doctors or medical institutions to whom benefits may be provided that are regulated by a set of regulations. In step 504, the input unit 204 may receive input category data as indicated by the user.

In step 506, the transmitting unit 208 (e.g., via the reporting module 216) may report the category data as selected by the user. In one embodiment, the category data may be reported to the processing server 102. In another embodiment, the category data may be reported to a third party. In step 508, the receiving unit 206 may receive aggregate spending data corresponding to the category selected by the user. Data that may be included as part of the aggregate spending data will be apparent to persons having skill in the relevant art and may include spending made in the corresponding category for at least one predetermined period of time, such as weekly, monthly, and annual spending.

In step 510, the processing unit 210 may determine if the received aggregate data includes an indication of non-compliance. For example, non-compliance may be indicated by an aggregate spending value exceeding a provided aggregate spending limit. If there is no indication of non-compliance (e.g., the user and/or the organization is within compliance), then, in step 512, the display unit 202 may display the received data to the user and the process 500 may end.

If there is an indication of non-compliance, then, in step 514, the aggregated data may be displayed to the user by the display unit 202, and then the processing unit 210 may determine if the user is to receive training, view the corresponding regulation, or neither. If the user is to receive training, then the user may be taken to the training module 218, such as for participating in a training scenario involving the regulation for which there was non-compliance. If the user is to receive information, then the user may be taken to the information module 222, such as to be presented with the corresponding regulation. If the user is to receive neither, then the process 500 may end.

Although the process 500 of FIG. 5 illustrates the aggregate data displayed to the user to be spending data, it will be apparent to persons having skill in the relevant art that the spending module 220 may be configured to receive a request for and display any suitable type of data to the user. For example, the user may request data regarding timelines and/or dates for a specific action or category of actions, and may be presented with the corresponding data, which may include an indication of non-compliance if the data indicates that the user and/or organization has missed a required deadline.

In some embodiments, the spending module 220 may be further configured to receiving spending information from the user. For example, the input unit 204 may receive spending information from the user, which may include a spending amount, a time and/or date of spending, a location, and a category for which the spending occurred (e.g., the doctor for which a meal was provided). The spending information may be transmitted to the reporting module 216, which may report (e.g., via the transmitting unit 208) the spending information to the processing server 102 and/or a third party. The spending information may be used to calculate (e.g., identify, generate, tabulate, etc.) an aggregate spending amount for the corresponding category, which may be included in the aggregate spending data received by the receiving unit 206 in step 508. In a further embodiment, the input unit 204 of the computing device may include, for example, a camera or a scanner to capture an image of a receipt, such as to provide proof of the spending or to be saved by the system operator 108 for taxation purposes.

### Information Module

The information module 222 may be a module configured to present the user with information regarding the set of regulations for which the user is to comply. The receiving unit 206 may receive content from the processing server 102. The received content may include customized content based on a user identifier associated with the user mobile device 110, as discussed above. The received content may include a plurality of content items corresponding to the set of regulations, which may be specific to the user as indicated in the user database 104. In some embodiments, the system operator 108 may set which content items are included for the particular user. The plurality of content items may include, for example, the set of regulations, specific regulations, specific passages of regulations, company policies, codes of conduct, laws, etc. In one embodiment, the content items may further include news items, compliance offer messages (e.g., from the system operator 108 or other compliance personnel), administrative content, blogs, etc. For example, the content items may include a compliance tip of the day that may be updated daily and may additionally be customized to the user.

The display unit 202 may display the plurality of content items to the user. Methods for displaying a plurality of content items for selection by a user will be apparent to persons having skill in the relevant art. The input unit 204 may receive user input selecting one of the content items of the plurality of content items. The processing unit 210 may then identify content corresponding to the selected content item (e.g., in the computer-readable storage medium 212 or using the receiving unit 206 and transmitting unit 208 to receive the content via the network 114). The display unit 202 may display the content corresponding to the selected content item to the user.

The information module 222 may be further configured to receive requests to display information from other modules, such as the training module 218 and the spending module 220. For example, the training module 218 may direct the user to the information module 222 to display a specific regulation as a result of an incorrect response in a compliance scenario. The information module 222 may receive an identifier of the specific regulation, and may display the corresponding regulation to the user via the display unit 202. In one embodiment, the information module 222 may display the complete rules or regulations that include the corresponding regulation to the user via the display unit 202. In some instances, the information module 222 may return the user to the corresponding module once the specified information has been viewed.

It will be apparent to persons having skill in the relevant art that the information module 222 may include additional features to assist the user with locating and/or reviewing regulations. For example, the information module 222 may be configured to enable a user to search for a regulation (e.g., by searching for a specific regulation, for a keyword in any regulation, etc.). In some instances, the information module may be connected with the question module 224 (e.g., to enable a user to ask a question about a regulation being viewed) or the reporting module 216 (e.g., to enable a user to report misconduct regarding the regulation being viewed, to enable the processing server 102 to keep an auditable trail of regulations viewed by the user, etc.).

### Additional Modules

As illustrated in FIGS. 2 and 3, the application program 214 may include additional interconnected modules to further assist the user with compliance with the set of regulations, such as the question module 224 and the forms module 226.

The question module 224 may be configured to receive questions from a user to be made available for answer by the system operator 108 or other compliance personnel, and may also be configured to display answers to all or specially selected questions that have been answered to the user. The display unit 202 may display an input field to the user, where the user may input, via the input unit 204, their question. The transmitting unit 208 may transmit the question to the processing server 102, to be answered by compliance personnel.

Once the question has been answered, the receiving unit 206 may receive the answer. In some embodiments, the display unit 202 may display, or the transmitting unit 208 may transmit, an indication to the user that their question has been answered. For example, an icon or notification may be displayed on the display unit 202, the user mobile device 110 may receive a short message service (SMS) message of the answer or indicating the answer, or the user may receive an e-mail. In some embodiments, the icon or notification may be automatically displayed every time an answer has been received. In other embodiments, the system operator 108 may indicate if the icon or notification is to be displayed on receipt of a particular answer. The user may request (e.g., via the input unit 204) to view the answer, which may then be displayed to the user by the display unit 202.

In some embodiments, the question module 224 may be configured to display a list of all answered questions to the user via the display unit 202. In a further embodiment, the list of questions displayed to the user may be based on the received customized content received by the receiving unit 206 and/or may be based on indications in the user database 104 (e.g., and set by the system operator 108). The question module 224 may then receive a selected question and display the question and answer to the user using the input unit 204, processing unit 210, and display unit 202, such as by using the same method used by the information module 222 for displaying content as discussed above.

The forms module 226 may be a module configured to allow a user to input data into a form (e.g., a personnel form, compliance form, etc.), which may be reported to the processing server 102 via the reporting module 216. The forms module 226 may display a form to the user via the display unit 202, or may display input fields to a user corresponding to fields on the form. The input unit 204 may receive form data input by the user, which may be provided to the reporting module 216 to report to the processing server 102. The system operator 108 may then access the form data from the processing server 102 to print, file, store, etc. the form for use in maintaining compliance with the set of regulations.

Even more additional modules may be further included in the program 214 as will be apparent to persons having skill in the relevant art. A search module may be included, which may enable a user or administrator to search one or more modules for a specific term. The search module may be configured to display content related to the search term from one or more (e.g., selected by the user searching, set by the administrator, etc.). For example, the user may search for a compliance term and may be presented with compliance scenarios from the training module 218, with information from the information module 222, and questions from the question module 224.

In some instances, the search module may be configured to compile and calculate statistics regarding searches, which may then be reviewed by an administrator. For example, the search module may identify statistics regarding the frequency of certain search terms, actions taken by users following a search (e.g., whether users viewed information or answered compliance scenarios), etc. and may identify correlations between search terms and compliance. The administrator may then review the statistics and add compliance scenarios, information, or reports accordingly. In one example, an administrator may identify that a large number of users continually search for information regarding a specific regulation based on data presented by the search module, and may then include a frequently asked question in the question module 224 regarding the specific regulation.

The program 214 may also include an alert or tickler feature. Such an alert or feature may be integrated into an existing module or modules (e.g., the reporting module 216) for alerting an administrator regarding certain upcoming or recently occurring events. For example, an alert or notification may be transmitted to an administrator (e.g., as discussed in more detail below), which may indicate an upcoming date or deadline for a compliance action to be performed, such as a form that must be produced for compliance with a regulation. Such alerts may be set as part of the feature or module itself in the program 214 and may be added to or modified by a user (e.g., the administrator). In some instances, the administrator may set alerts to be provided to users, such as reminders for training, reporting, submitting forms, etc.

### Graphical User Interface

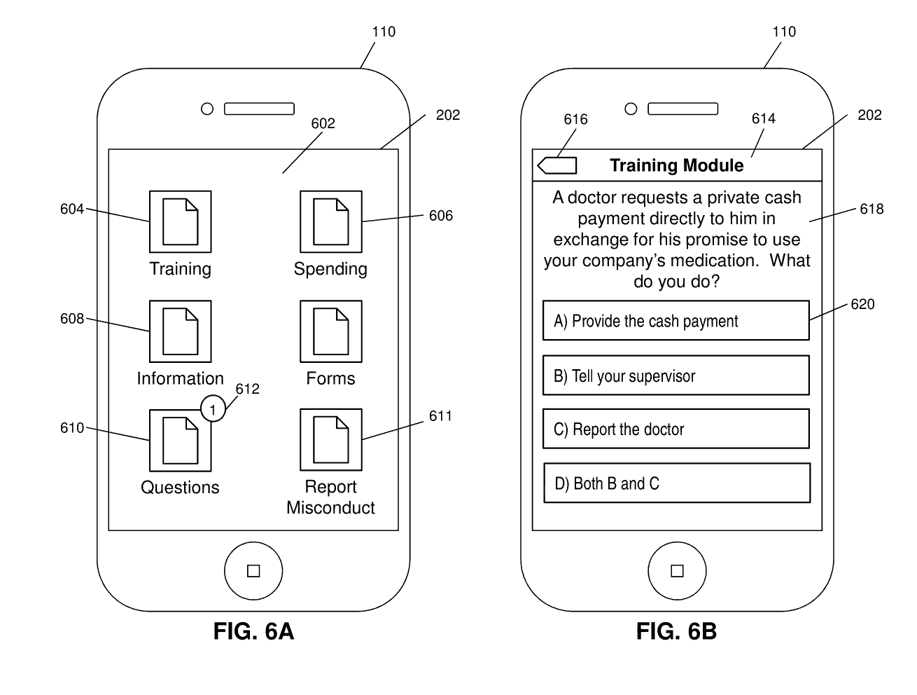

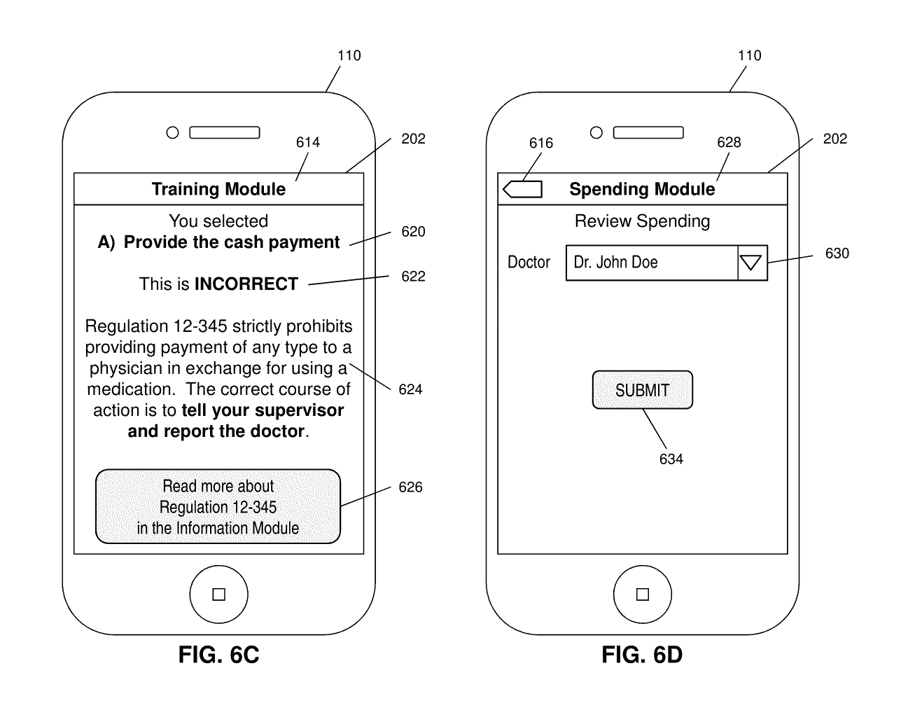

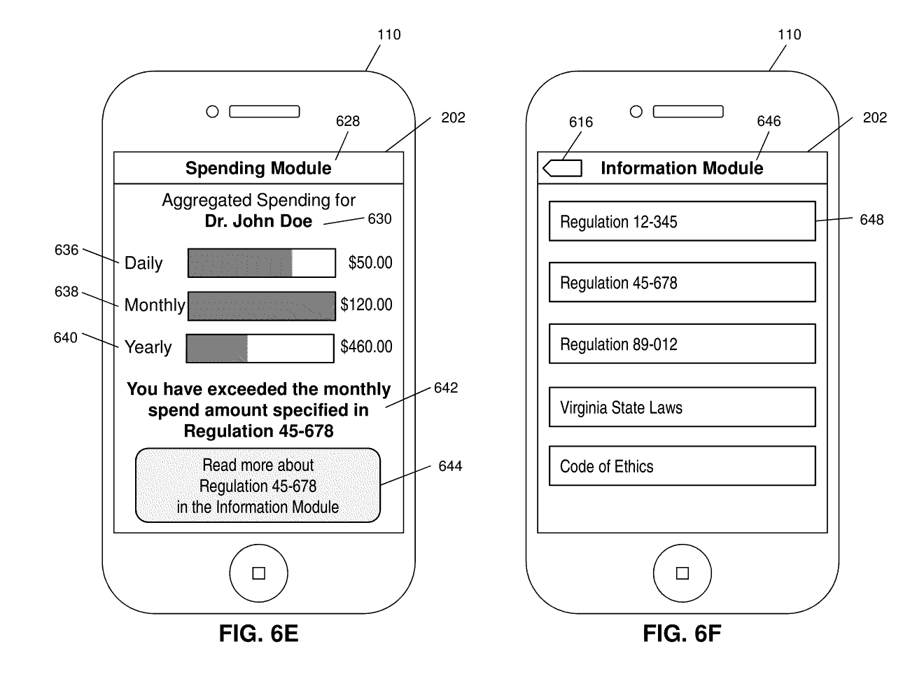

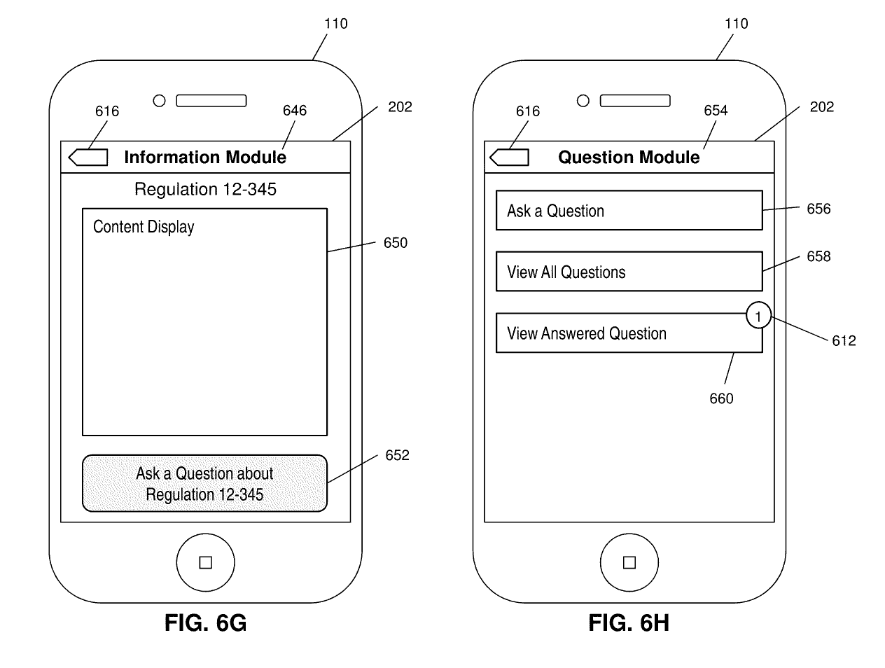

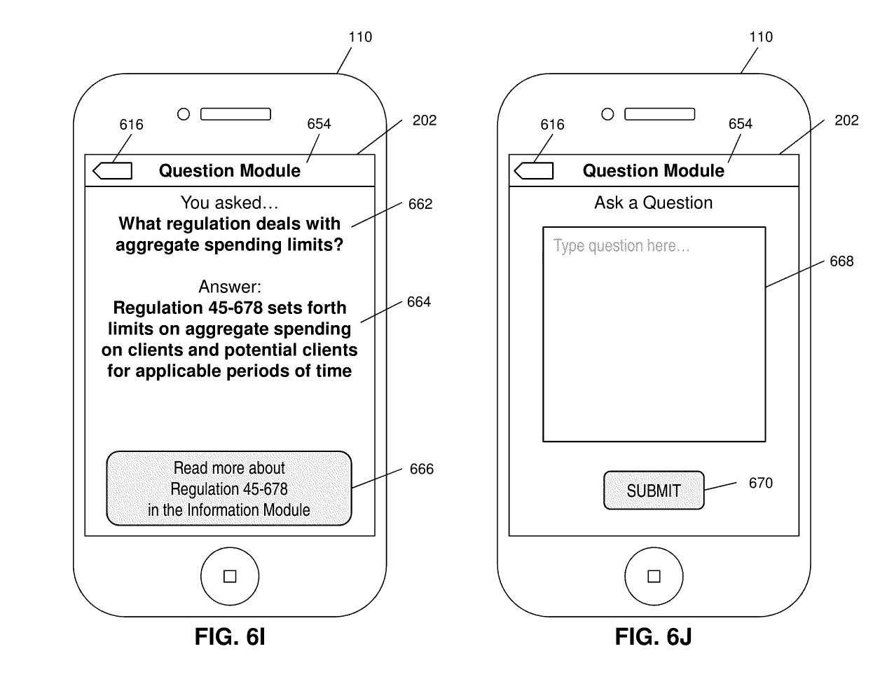

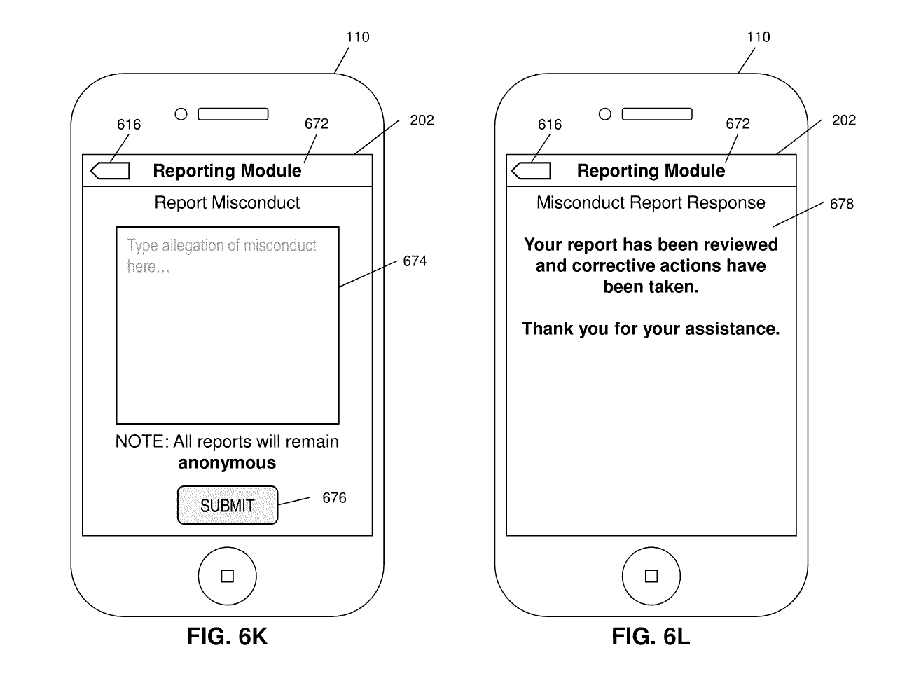

FIGS. 6A-6L illustrate exemplary graphical user interfaces of the user mobile device 110 including the interconnected modules of the application program 214. It should be understood that the various graphical user interfaces described herein are presented for purposes of example only. Other interfaces suitable for the system and method for assisting a user with compliance as disclosed herein will be apparent to persons having skill in the relevant art.

In FIG. 6A, the display unit 202 of the user mobile device 110 is illustrated as displaying a menu 602. The menu 602 may include a plurality of menu icons, which, when interacted with by a user (e.g., via the input unit 204) may present the user with another screen. As illustrated in FIG. 6A, the menu 602 may include a training button 604, a spending button 606, an information button 608, a questions button 610, and a report misconduct button 611. In some embodiments, when the receiving unit 206 receives a content update, the display unit 202 may display an indication 612 of the received update. For example, the indication 612 as illustrated in FIG. 6A may indicate that a question submitted by the user using the question module 224 has been answered.

If the user interacts with the training button 604, then her or she may be presented with the training module screen 614 as illustrated in FIG. 6B. The training module screen 614 may include a return button 616, which may be configured to return the user to the previous screen, such as the menu 602. The training module screen 614 may further include a compliance scenario 618 and a plurality of user responses 620. The plurality of user responses 620 may include multiple choice responses (as illustrated in FIG. 6B), true or false responses, matching responses, etc. The input unit 204 may receive input from the user selecting one of the user responses 620, which may result in the training module screen 614 displaying a response as illustrated in FIG. 6C.

In FIG. 6C, the training module screen 614 may display the selected user response 620 and a response indicator 622. The response indicator 622 may indicate if the response is correct or incorrect. In some embodiments, the response indicator 622 may be a point value, such as one indicating the level of correctness of the response. In a further embodiment, the response indicator 622 may include additional point values, such as a value of total points the user has earned, total points for scenarios 618 involving the same regulation, or the average point value earned for the scenario 618 by other users.

The training module screen 614 may further include a scenario explanation 624. The scenario explanation 624 may include an explanation as to the correct user response 620 for the scenario 618 and an explanation as to the reasoning. In some instances, such as illustrated in FIG. 6C when the user has selected an incorrect user response 620, the training module screen 614 may include an information button 626. The information button 626 may connect the user to the information module 222 to display content associated with the scenario 618, such as the corresponding regulation or a set of rules or regulations including a specific rule or regulation corresponding to the scenario 618. In some instances, the training module screen 614 may not include the return button 616 such that the user is required to interact with the information button 626 and view the content. In some embodiments, the display of the return button 616 may be configured by the system operator 108.

If the user interacts with the spending button 606 of the menu 602, then the display unit 202 may display the spending module screen 628 as illustrated in FIG. 6D. The spending module screen 628 may include a spend category 630, illustrated as a drop-down menu from which the user may select the spend category. It will be apparent to persons having skill in the relevant art that the spend category 630 may also be selected by using a list, an input field, or other suitable method. The spending module 220 may (e.g., via the reporting module 216) transmit the selected spend category 630 once the user hits a submit button 634.

Once the spending module 220 receives, via the receiving unit 206, aggregate spending data corresponding to the selected spend category 630, then the spending module screen 628 may display aggregate spending data as illustrated in FIG. 6E. The spending module screen 628 may include the spend category 630, a daily aggregate spending amount 636, a monthly aggregate spending amount 638, and a yearly aggregate spending amount 640. In an instance where the user and/or organization may be non-compliant with a regulation based on the aggregate spending, such as the case in FIG. 6E where the monthly aggregate spending amount 638 is indicated as exceeding a limit, then the spending module screen 628 may display a compliance message 642. The spending module screen 628 may also display an information button 644, which may connect the user to the information module 222 to display the regulation for which there was non-compliance.

If the user interacts with the information button 608 of the menu 602, then the display unit 202 may display the information module screen 646 as illustrated in FIG. 6F. The information module screen 646 may include the return button 616 and a plurality of content items 648. The user may interact with one of the content items 648 via the input unit 204. The processing unit 210 may identify the content item 648 and content corresponding to the content item 648, which may then be displayed by the information module screen 646 as illustrated in FIG. 6G.

The information module screen 646 may display a content display 650, which may be the content corresponding to the selected content item 648. In some instances, the information module screen 646 may also include a question button 652. The question button 652 may connect the user to the question module 224, so that the user may be able to ask a question about the content item 648. In some instances, the question module 224 may be configured such that a prompt for the question from the user may be pre-filled with information identifying the content item 648 the user was viewing prior to interacting with the question button 652.

If the user interacts with the question button 610 of the menu 602, then the display unit 202 may display the question module screen 654 as illustrated in FIG. 6H. The question module screen 654 may include a menu of buttons, such as a question ask button 656, a view questions button 658, and an answered question button 660. In some instances, if the receiving unit 206 has a received an answer to a question submitted by the user that has not yet been viewed, then the update indicator 612 may be displayed to indicate the received answer. In one embodiment, the answered question button 660 may not be displayed unless there is at least one received answer not yet viewed by the user.

When the user interacts with the answered question button 660, the question module screen 654 may display the user question 662, the received answer 664, and an information button 666, as illustrated in FIG. 61. The information button 666 may connect the user to the information module 222, which may display a content display 650 of a regulation or other content item 648 related to the user question 662 and/or the received answer 664. If the user interacts with the question ask button 656, then the question module screen 654 may display a question input field 668 and a submit button 670, as illustrated in FIG. 6J. The user may input their question to the question input 668 via the input unit 204, which may be transmitted to the processing server 102 by the transmitting unit 208 upon the user interacting with the submit button 670.

If the user interacts with the misconduct reporting button 611 of the menu 602, then the display unit 202 may display the reporting module screen 672, as illustrated in FIG. 6K. The reporting module screen 672 may include a misconduct input 674 and a submit button 676. The input unit 204 may receive user input of data for the misconduct input 674. When the user interacts with the submit button 676, the reporting module 216 may (e.g., via the transmitting unit 208) report the misconduct input 674 to the processing server 102. In an exemplary embodiment, the misconduct input 674 may be reported anonymously. As illustrated in FIG. 6L, once the reporting module 214 has reported the misconduct input 674 then the reporting module screen 672 may display a confirmation message 678 indicating the transmission of the reported misconduct.

Exemplary Method for Assisting a User with Compliance

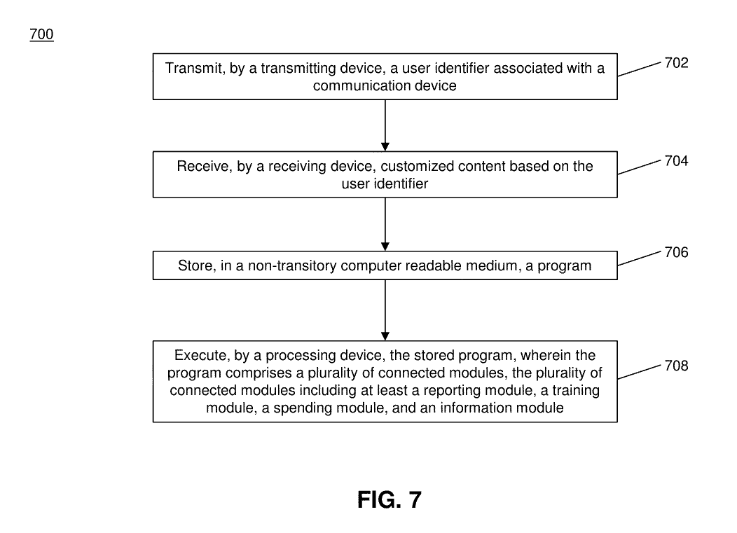

FIG. 7 illustrates a method 700 for assisting a user with compliance with a set of regulations.

In step 702, a user identifier associated with a communication device (e.g., the user computer 112, the user mobile device 110, and the system operator 108, etc.) may be transmitted by a transmitting device (e.g., the transmitting unit 208). In one embodiment, the user identifier may be a media access control address. In step 704, a receiving device (e.g., the receiving unit 206) may receive customized content based on the user identifier. In step 706, a program (e.g., the application program 214) may be stored in a non-transitory computer readable medium (e.g., the computer-readable storage medium 212).

In step 708, a processing device (e.g., the processing unit 210) may execute the stored application program 214, wherein the program comprises a plurality of connected modules, the plurality of connected modules including at least a reporting module (e.g., the reporting module 216), a training module (e.g., the training module 218), a spending module (e.g., the spending module 220), and an information module (e.g., the information module 222).

The training module 218 may be configured to display, on a display device (e.g., the display unit 202), a compliance scenario. In one embodiment, the received customized content may include the compliance scenario. The training module may be further configured to: receive, via an input device (e.g., the input unit 204), a user response to the displayed compliance scenario; identify a scenario explanation based on the received user response; display, on the display unit 202, the identified scenario explanation, and cause the reporting module 216 to report, via the transmitting unit 208, the received user response. In some embodiments, the compliance scenario may be an ethical situation for which the user must select from a plurality of available responses, and wherein the received user response is an indication of one response of the plurality of available responses.

The spending module 220 may be configured to: receiving, via the input unit 204, an indication of a spending category; cause the reporting module to report, via the transmitting unit 208, the received indication of a spending category; receiving, via the receiving unit 206, aggregate spending data corresponding to the indicated spending category; display, on the display unit 202, the received aggregate spending data; and identify, in the received aggregate spending data, an indication of noncompliance with at least one regulation in the set of regulations.

The information module 222 may be configured to: display, on the display unit 202, a plurality of content items based on at least the received customized content; receive, via the input unit 204, an indication of a selected content item of the plurality of content items; display, on the display unit 202, content associated with the selected content item. In one embodiment, the plurality of content items may include at least one of: a code of conduct, a set of regulations, a state law, administrative content, compliance officer messages, and industry news. In a further embodiment, the compliance officer messages may be included in a blog. In another embodiment, the plurality of content items may be included in the received customized content. The information module 222 may be further configured to receive, from another module, an indication of compliance or noncompliance with at least one regulation in the set of regulations, and display, on the display unit 202, content associated with the at least one regulation.

In one embodiment, the reporting module 216 may be configured to: receive, via the input unit 204, an allegation of misconduct; report, to a third party, the allegation of misconduct, wherein the allegation is report anonymously; receive, via the receiving unit 206, a response to the allegation of misconduct; and display, on the display unit 202, the received response. In a further embodiment, the display unit 202 may be configured to display an indication that the response to the allegation of misconduct has been received by the receiving unit 206.

In another embodiment, the reporting module 216 may be further configured to report an indication of attendance of a training event. In some embodiments, the method 700 may further include receiving, by the receiving unit 206, a content update, and displaying, by the display unit 202, an indication that the content update has been received.

In one embodiment, the plurality of connected modules may further include a forms module (e.g., the forms module 226). The forms module 226 may be configured to: display, on the display unit 202, a plurality of forms; receiving, via the input unit 204, a selection of one form of the plurality of forms; display, on the display unit 202, a plurality of input fields based on the selected one form; receive, via the input unit 204, form data entered by the user in each of the plurality of input fields; and cause the reporting module 216 to report the received form data. In a further embodiment, the form data may include at least one of an electronic signature and authentication information. In a further embodiment, the authentication information may include a username, a password, or a fingerprint.

In another embodiment, the plurality of connected modules may further include a question module (e.g., the question module 224). The question module 224 may be configured to: receive, via the input unit 204, a question; cause the reporting module 216 to report the question; receive, via the receiving device 206, an answer to the question; and display, on the display unit 202, the received answer. In a further embodiment, the reporting module 216 may be configured to report the question anonymously. In another further embodiment, the display unit 202 may be configured to display an indication that the answer to the question has been received by the receiving device.

Techniques consistent with the present disclosure provide, among other features, a system and method for assisting a user with compliance with a set of regulations. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A communication device, comprising:
a display device;
an input device;
a transmitting device configured to transmit at least a user identifier associated with the communication device;
a receiving device configured to receive customized content based on the user identifier associated with the communication device;
a non-transitory computer-readable storage medium configured to store a program; and
a processing device configured to execute the program,
wherein the program comprises a plurality of connected modules to assist a user with compliance with a set of regulations, the plurality of connected modules including
a reporting module;
a training module configured to
display, on the display device, a compliance scenario,
receive, via the input device, a user response to the displayed compliance scenario,
identify a scenario explanation based on the received user response,
display, on the display device, the identified scenario explanation, and
cause the reporting module to report, via the transmitting device, the received user response;
a spending module configured to
receive, via the input device, an indication of a spending category,
cause the reporting module to report, via the transmitting device, the received indication of a spending category,
receive, via the receiving device, aggregate spending data corresponding to the indicated spending category,
display, on the display device, the received aggregate spending data, and
identify, in the received aggregate spending data, an indication of noncompliance with at least one regulation in the set of regulations; and
an information module configured to
display, on the display device, a plurality of content items based on at least the received customized content,
receive, via the input device, an indication of a selected content item of the plurality of content items,
display, on the display device, content associated with the selected content item,
receive, from another module, an indication of compliance or noncompliance with at least one regulation in the set of regulations, and
display, on the display device, content associated with the at least one regulation.

2. The system of claim 1, wherein the received customized content includes the compliance scenario.

3. The system of claim 1, wherein the compliance scenario is an ethical situation for which the user must select from a plurality of available responses, and wherein the received user response is an indication of one response of the plurality of available responses.

4. The system of claim 1, wherein the plurality of content items includes at least one of: a code of conduct, the set of regulations, a state law, administrative content, compliance officer messages, and industry news.

5. The system of claim 1, wherein the received customized content includes the plurality of content items.

6. The system of claim 1, wherein the plurality of connected modules further comprises a forms module, wherein the forms module is configured to
display, on the display device, a plurality of forms;
receive, via the input device, a selection of one form of the plurality of forms;
display, on the display device, a plurality of input fields based on the selected one form;
receive, via the input device, form data entered by the user in each of the plurality of input fields; and
cause the reporting module to report the received form data.

7. The system of claim 6, wherein the form data may include at least one of an electronic signature and authentication information.

8. The system of claim 1, wherein the plurality of connected modules further comprises a question module, wherein the question module is configured to
receive, via the input device, a question;
cause the reporting module to report the question;
receive, via the receiving device, an answer to the question; and
display, on the display device, the received answer.

9. The system of claim 7, wherein the reporting module is configured to report the question anonymously.

10. The system of claim 7, wherein the display device is configured to display an indication that the answer to the question has been received by the receiving device.

11. The system of claim 1, wherein the reporting module is further configured to
receive, via the input device, an allegation of misconduct;
report, to a third party, the allegation of misconduct, wherein the allegation is reported anonymously;
receive, via the receiving device, a response to the allegation of misconduct; and
display, on the display device, the received response.

12. The system of claim 11, wherein the display device is configured to display an indication that the response to the allegation of misconduct has been received by the receiving device.

13. The system of claim 1, wherein
the receiving device is further configured to receive a content update; and
the display device is configured to display an indication that the content update has been received.

14. The system of claim 1, wherein the reporting module is further configured to report an indication of attendance of a training event.

15. The system of claim 1, wherein the user identifier is a media access control address.

16. A method for assisting a user with compliance with a set of regulations, comprising:
transmitting, by a transmitting device, a user identifier associated with a communication device;
receiving, by a receiving device, customized content based on the user identifier;
storing, in a non-transitory computer readable storage medium, a program; and
executing, by a processing device, the stored program,
wherein the program comprises a plurality of connected modules, the plurality of connected modules including
a reporting module;
a training module configured to
display, on the display device, a compliance scenario,
receive, via the input device, a user response to the displayed compliance scenario,
identify a scenario explanation based on the received user response,
display, on the display device, the identified scenario explanation, and
cause the reporting module to report, via the transmitting device, the received user response;
a spending module configured to
receive, via the input device, an indication of a spending category,
cause the reporting module to report, via the transmitting device, the received indication of a spending category,
receive, via the receiving device, aggregate spending data corresponding to the indicated spending category,
display, on the display device, the received aggregate spending data, and
identify, in the received aggregate spending data, an indication of noncompliance with at least one regulation in the set of regulations; and
an information module configured to
display, on the display device, a plurality of content items based on at least the received customized content,
receive, via the input device, an indication of a selected content item of the plurality of content items,
display, on the display device, content associated with the selected content item,
receive, from another module, an indication of compliance noncompliance with at least one regulation in the set of regulations, and
display, on the display device, content associated with the at least one regulation.

17. The method of claim 16, wherein the received customized content includes the compliance scenario.

18. The method of claim 16, wherein the compliance scenario is an ethical situation for which the user must select from a plurality of available responses, and wherein the received user response is an indication of one response of the plurality of available responses.

19. The method of claim 16, wherein the plurality of content items includes at least one of: a code of conduct, the set of regulations, a state law, administrative content, compliance officer messages, and industry news.

20. The method of claim 16, wherein the received customized content includes the plurality of content items.

21. The method of claim 16, wherein the plurality of connected modules further comprises a forms module, wherein the forms module is configured to
display, on the display device, a plurality of forms;
receive, via the input device, a selection of one form of the plurality of forms;
display, on the display device, a plurality of input fields based on the selected one form;
receive, via the input device, form data entered by the user in each of the plurality of input fields; and
cause the reporting module to report the received form data.

22. The method of claim 21, wherein the form data may include at least one of an electronic signature and authentication information.

23. The method of claim 16, wherein the plurality of connected modules further comprises a question module, wherein the question module is configured to
receive, via the input device, a question;
cause the reporting module to report the question;
receive, via the receiving device, an answer to the question; and
display, on the display device, the received answer.

24. The method of claim 23, wherein the reporting module is configured to report the question anonymously.

25. The method of claim 23, further comprising:
displaying, by the display device, an indication that the answer to the question has been received by the receiving device.

26. The method of claim 16, wherein the reporting module is further configured to
receive, via the input device, an allegation of misconduct;
report, to a third party, the allegation of misconduct, wherein the allegation is reported anonymously;
receive, via the receiving device, a response to the allegation of misconduct; and
display, on the display device, the received response.

27. The method of claim 26, wherein the display device is configured to display an indication that the response to the allegation of misconduct has been received by the receiving device.

28. The method of claim 16, further comprising:
receiving, by the receiving device, a content update; and
displaying, by the display device, an indication that the content update has been received.

29. The method of claim 16, wherein the reporting module is further configured to report an indication of attendance of a training event.

30. The method of claim 16, wherein the user identifier is a media access control address.
